(19) United States
(12) Patent Application Publication
(10) Pub. No.: US 2009/0289918 A1
(43) Pub. Date: Nov. 26, 2009

(54) INPUT DEVICE

(75) Inventor: Tetsuo MURANAKA, Fukushima-ken (JP)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: ALPS ELECTRIC CO., LTD, Tokyo (JP)

(21) Appl. No.: 12/469,814

(22) Filed: May 21, 2009

(30) Foreign Application Priority Data
May 21, 2008 (JP) 2008-133157

(51) Int. Cl. G06F 3/044; G08C 21/00

(52) U.S. Cl. 345/174; 178/18.06

(57) ABSTRACT

An input device includes a plurality of X scan electrodes, a plurality of Y scan electrodes, and common detection electrode forming capacitance with the X scan electrodes and the Y scan electrodes. In the cycles, a second driving signal is supplied to the same Y scan electrode, and in each of the cycles, a first driving signal is sequentially supplied to the X scan electrodes. Two positions touched by fingers are detected from detection current to be obtained by the detection electrodes.

### CROSS REFERENCE TO RELATED REFERENCES

The present invention contains subject matter related to and claims the benefit of Japanese Patent Application JP 2008-133157 filed in the Japanese Patent Office on May 21, 2008, the entire contents of which is incorporated herein by reference.

### BACKGROUND OF THE DISCLOSURE

1. Technical Field

The present invention relates to an input device that detects a change in electrostatic capacitance to detect the approach of a control object, such as a finger of a human body or the like, and in particular, to an input device that is capable of detecting the approach of the control object at a plural number of positions.

2. Related Art

Various electronic apparatuses, such as a personal computer and the like, are provided with an input device which has a flat plate-shaped scan pad. In such an input device, if a finger touches the surface of the scan pad, the position touched by the finger is detected as the coordinate position of the surface of the scan pad. The input operation to various electronic apparatuses is made by detection of the position touched by the finger.

Such a known input device may generally detect only that the finger touches one position of the input pad. However, in some electronic apparatuses, when the finger touches a plural number of positions of the input pad, it is necessary to individually detect the positions touched by the finger.

Accordingly, Japanese Unexamined Patent Application Publication Nos. 7-230352 and 8-16307 disclose an input device that can detect the positions of the finger having touched a plural number of positions of the input pad.

In the input device described in Japanese Unexamined Patent Application Publication No. 7-230352, a plurality of X-direction electrodes and a plurality of Y-direction electrodes are provided, and an AC signal is applied to the X-direction electrodes and the Y-direction electrodes. If the finger approaches the intersection of one X-direction electrode and one Y-direction electrode, cross capacitance between the X-direction electrode and the Y-direction electrode is attenuated, and the AC signal between the X-direction electrode and the Y-direction electrode is decreased in level. If the AC signal is sequentially applied to the X-direction electrodes and the Y-direction electrodes, when the finger approaches a plural number of positions, the electrode intersections where the finger has approached can be individually detected.

The input device described in Japanese Unexamined Patent Application Publication No. 8-16307 uses a surface acoustic wave touch plate or a two-dimensional optical sensor array touch plate. In this input device, when the finger touches multi points, the positions touched by the finger can be individually detected.

### SUMMARY OF THE DISCLOSURE

In order to individually detect a plural number of positions where the finger has approached, it is necessary to sequentially view cross capacitance of all the electrode intersections. To this end, it is necessary to individually detect a change of the signal between the selected X-direction electrode and the selected Y-direction electrode, and to execute the detection while sequentially switching all of the X-direction electrodes and the Y-direction electrodes. This detection method causes an increase in the load of the detection circuit. In addition, since it is necessary to sequentially examine the change in cross capacitance of all the intersections, it takes a lot of time to scan all the intersections of the input panel. As a result, a rapid detection operation may not be made.

Also, the touch plate is complex in structure and expensive, and the detection circuit becomes complicated. As a result, this input device is not practical.

It is therefore desirable to provide an input device that, a control object, such as a finger or the like, touches a plural number of positions simultaneously, can individually detect the touch positions by using an input pad with a comparatively simple configuration for detecting a change in electrostatic capacitance between electrodes.

An input device according to various embodiments may include a plurality of X scan electrodes extending in a Y direction to be arranged with intervals in an X direction perpendicular to the Y direction, a plurality of Y scan electrodes extending in the X direction to be arranged with intervals in the Y direction, the Y scan electrodes being insulated from the X scan electrodes, detection electrodes forming electrostatic capacitance with the X scan electrodes and the Y scan electrodes, an X driver supplying a pulsed driving signal to the X scan electrodes, a Y driver supplying a pulsed driving signal to the Y scan electrodes, and a detection unit detecting scan electrodes to be approached by a control object from detection signals to be obtained from the detection electrodes and the timing at which the driving signals are supplied to the X scan electrodes and the Y scan electrodes. The driving signal that is supplied from the X driver to the X scan electrodes and the driving signal that is supplied from the Y driver to the Y scan electrodes may be opposite in the timing of rising and falling of the pulses, and at the same scan time, one X scan electrode and one Y scan electrode are selected simultaneously and the driving signals are supplied to the selected X and Y scan electrodes. Let a predetermined number of repetitions of scan time be one cycle, then, in a first cycle, the same Y scan electrode is selected in all of the scan time and different X scan electrodes are selected at the respective scan time, and in a second cycle, a Y scan electrode different from the Y scan electrode in the first cycle is selected in all of the scan time and different X scan electrodes are selected at the respective scan time. The cycles where different Y scan electrodes are selected may be repeated a predetermined number of times.

In the input device according to an embodiment, when the driving signals are supplied sequentially to the X scan electrodes and the Y scan electrodes, by detecting the detection signals from a smaller number of detection electrodes than the scan electrodes, for example, the detection signal from one detection electrode, a scan electrode to be approached by the control object can be recognized. Unlike the related art in which a detection signal is detected while switching a plurality of electrodes, the detection circuit can be simplified. In addition, because two kinds of driving signals that are opposite in the timing of rising and falling are supplied to the x scan electrodes and the Y scan electrodes, when the control object approaches a plural number of positions, the positions of the control object can be individually detected.

In the input device according to an embodiment, the detection unit may detect scan electrodes to be approached by a plurality of control objects from the detection signals to be obtained from the detection electrodes and the timing at which the driving signals are supplied to the X scan electrodes and the Y scan electrodes.

In the input device according to an embodiment, in the same cycle, adjacent X scan electrodes may be sequentially selected at the respective scan time, and in different cycles, adjacent Y scan electrodes may be sequentially selected.

If adjacent X scan electrodes are sequentially selected, when a control object, such as a finger or the like, approaches an intermediate position between adjacent X scan electrodes, the approach position of the control object in the middle of adjacent X scan electrodes can be accurately recognized by comparing the magnitudes of the detection signals when both the X scan electrodes are selected. In addition, if adjacent Y scan electrodes are sequentially selected, similarly, the approach position of the control object in the middle of adjacent Y scan electrodes can be accurately recognized.

The X direction and the Y direction used herein are used to distinguish orthogonal directions, and the X scan electrodes or the Y scan electrodes are not intended to limit the extension direction of the corresponding electrodes. For example, the electrodes X0 to X3 shown in FIG. 1 may be Y scan electrodes, and the electrodes Y0 to Y3 may be X scan electrodes.

According to an embodiment, detection signals may be detected by common detection electrode provided separately from X scan electrodes and Y scan electrodes. For this reason, in a detection circuit, complex processing, such as detection electrode switching or the like, may not be needed, and as a result, the approach position of a control object can be rapidly detected with comparatively simple configuration. In addition, when the control object approaches a plural number of positions, the approach positions can be individually recognized.

### BRIEF DESCRIPTION OF THE DRAWINGS

FIG. 1 shows an embodiment of an input device, and is an explanatory view showing the arrangement of scan electrodes and detection electrodes;

FIG. 2A is a waveform chart of a first driving signal;

FIG. 2B is a waveform chart of a detection signal that is generated due to the first driving signal;

FIG. 2C is a waveform chart of a second driving signal;

FIG. 2D is a waveform chart of a detection signal that is generated due to the second driving signal;

FIG. 3 is an explanatory view of a first pattern where a finger touches two positions of an input device according to an embodiment of the disclosure;

FIG. 4A shows a switch timing of the first driving signal to be supplied to X scan electrodes in the first pattern;

FIG. 4B shows a switch timing of the second driving signal to be supplied to Y scan electrodes in the first pattern;

FIG. 4C shows detection currents to be obtained from detection electrodes in the first pattern;

FIG. 5 is an explanatory view of a second pattern where a finger touches two positions of an input device according to an embodiment of the disclosure;

FIG. 6A shows a switch timing of the first driving signal to be supplied to X scan electrodes in the second pattern;

FIG. 6B shows a switch timing of the second driving signal to be supplied to Y scan electrodes in the second pattern;

FIG. 6C shows detection currents to be obtained from detection electrodes in the second pattern;

FIG. 7 is an explanatory view of a third pattern where a finger touches two positions of an input device according to an embodiment of the disclosure;

FIG. 8A shows a switch timing of the first driving signal to be supplied to X scan electrodes in the third pattern;

FIG. 8B shows a switch timing of the second driving signal to be supplied to Y scan electrodes in the third pattern;

FIG. 8C shows detection currents to be obtained from detection electrodes in the third pattern;

FIG. 9 is an explanatory view of a fourth pattern where a finger touches two positions of an input device according to an embodiment of the disclosure;

FIG. 10A shows a switch timing of the first driving signal to be supplied to X scan electrodes in the fourth pattern;

FIG. 10B shows a switch timing of the second driving signal to be supplied to Y scan electrodes in the fourth pattern; and

FIG. 10C shows detection currents to be obtained from detection electrodes in the fourth pattern.

### DESCRIPTION OF EXEMPLARY EMBODIMENTS

The following description is intended to convey a thorough understanding of the embodiments described by providing a number of specific embodiments and details involving an input device. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

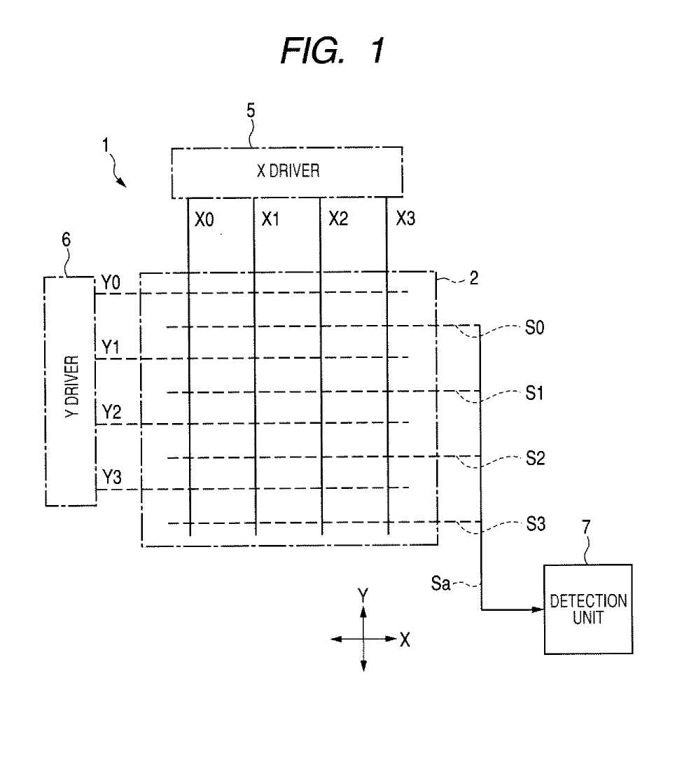

FIG. 1 shows an embodiment of an input device 1 of the invention, and a schematic explanatory view of the structure of the input device 1.

The input device 1 may include an input pad, and the input pad has a detection region 2 with a predetermined area in which an operation of a finger serving as a control object at a substantially ground potential can be made. The input pad may be provided with a plurality of X scan electrodes, a plurality of Y scan electrodes, and a plurality of detection electrodes.

Four X scan electrodes X0, X1, X2, and X3 may be provided in the detection region 2. The X scan electrodes may extend linearly in a Y direction and may be arranged in parallel. The X scan electrodes also may be arranged with predetermined pitches in an X direction. Four Y scan electrodes Y0, Y1, Y2, and Y3 may be provided in the detection region 2. The Y scan electrodes may extend linearly in the X direction and are arranged in parallel. The Y scan electrodes also may be arranged with predetermined pitches in the Y direction.

The four X scan electrodes and the four Y scan electrodes may intersect with each other within the detection region 2. At each intersection, the X scan electrode and the Y scan electrode may be insulated from each other. For example, the X scan electrodes and the Y scan electrode may be individually patterned on both sides of a film substrate made of synthetic resin. A synthetic resin layer which is cured by heat treatment may be interposed between the X scan electrodes and the Y scan electrodes.

Four detection electrodes S0, S1, S2, and S3 are provided in the detection region 2. The detection electrodes may extend linearly in the x direction, and may be arranged with predetermined pitches in the Y direction. The X scan electrodes and the detection electrodes also may be arranged in parallel with predetermined intervals in the Y direction.

As shown in FIG. 1, the detection electrode S0 may be disposed between the Y scan electrode Y0 and the Y scan electrode Y1. The detection electrode S1 may be disposed between the Y scan electrode Y1 and the Y scan electrode Y2, and the detection electrode S2 may be disposed between the Y scan electrode Y2 and the Y scan electrode Y3. The Y scan electrode Y3 may be disposed between the detection electrode S2 and the detection electrode S3.

The detection electrodes may be insulated from the X scan electrodes, and may be insulated from the Y scan electrodes. For example, the four detection electrodes may be formed on the same plane as the four Y scan electrodes.

According to various embodiments, the surface of the detection region 2 may be covered with an insulating sheet. In the input pad, the surface of the insulating sheet may become a planar input surface, and the X scan electrodes, the Y scan electrodes, and the detection electrodes are not exposed on the input surface.

The input device 1 shown in FIG. 1 may include, as the circuit configuration, an X driver 5, a Y driver 6, and a detection unit 7. The X driver 5 may select one of the four X scan electrodes X0, X1, X2, and X3, and supply a driving signal to the selected X scan electrode. The Y driver 6 may select one of the four Y scan electrodes Y0, Y1, Y2, and Y3 and supply a driving signal to the selected Y scan electrode. The four detection electrodes S0, S1, S2, and S3 collectively may be connected to a single detection line Sa, and a detection current to be obtained through the detection line Sa may be supplied to the detection unit 7.

The detection unit 7 may include a detection circuit (not shown) detecting the detection current serving as a detection signal obtained from the detection line Sa as a voltage value, an A/D conversion unit (not shown) converting the voltage value into a digital value, and an arithmetic unit (not shown) to which the converted digital value is supplied. In the arithmetic unit, a scan time is set with predetermined intervals. At each scan time, the driving signal may be supplied from the X driver 5 to the X scan electrode, and the driving signal may be supplied from the Y driver 6 to the Y scan electrode. In this embodiment, the driving signal may be supplied simultaneously to one X scan electrode and one Y scan electrode at the same scan time.

At each scan time, the arithmetic unit can detect a position of the input surface within the detection region 2 touched by a finger of a human body serving as a control object at a substantially ground potential from a change of the detection signal obtained by the detection unit 7 through the detection line Sa, the timing at which the driving signal is supplied from the X driver 5 to the X scan electrode, and the timing at which the driving signal is supplied from the Y driver 6 to the Y scan electrode.

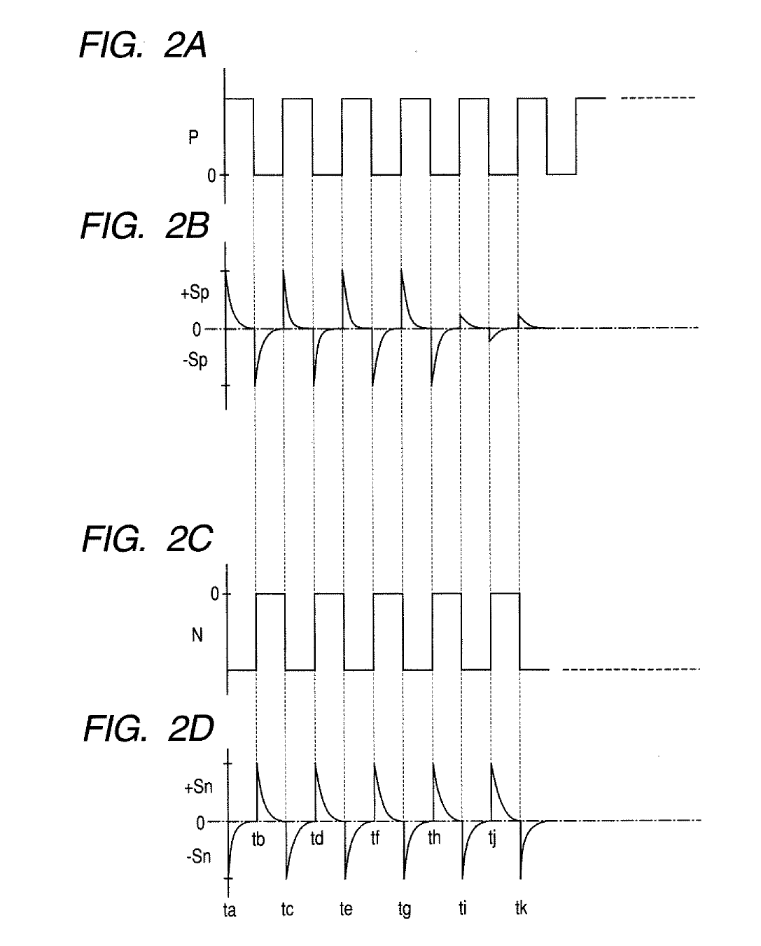

FIGS. 2A to 2D are waveform charts of a driving signal and a detection signal, which show the detection operation of the input device 1.

In the input device 1, capacitance may be formed between the detection electrode S0 and the Y scan electrodes Y0 and Y1 disposed on both sides of the detection electrode S0, and capacitance may be formed between the detection electrode S1 and the Y scan electrodes Y1 and Y2 disposed on both sides of the detection electrode S1. Similarly, capacitance may be formed between the detection electrode S2 and the Y scan electrodes Y2 and Y3 disposed on both sides of the detection electrode S2, and capacitance may be formed between the detection electrode S3 and the Y scan electrode Y3.

Capacitance also may be formed between the detection electrodes S0, S1, S2, and S3 and the X scan electrodes X0, X1, X2, and X3.

FIG. 2A shows a first driving signal P that is supplied sequentially to the X scan electrodes X0, X1, X2, and X3. FIG. 2C shows a second driving signal N that is supplied sequentially to the Y scan electrodes Y0, Y1, Y2, and Y3.

The first driving signal P shown in FIG. 2A is a pulse signal in which rising and falling are repeated on a plus side more than a reference potential (0). Voltage rises at time ta, tc, te, tg, ti, tk, . . . , and voltage falls at time tb, td, tf, th, tj, . . . . The second driving signal N shown in FIG. 2C is a pulse signal in which falling and rising are repeated on a minus side less than the reference potential (0). The first driving signal P and the second driving signal N are opposite in the timing of rising and falling of the pulses. In the second driving signal N, voltage falls at time ta, tc, te, tg, ti, tk, . . . , and voltage rises at time tb, td, tf, th, tj, . . . .

At a scan time, the first driving signal P may be supplied from the X driver 5 to one X scan electrode, and at the same scan time, the second driving signal N may be supplied from the Y driver 6 to one Y scan electrode simultaneously.

The reference potential (0) shown in FIG. 2 may be 0 volt, or a positive or negative potential of 2.5 volt or the like.

In the invention, the first driving signal P shown in FIG. 2A may be supplied to the Y scan electrode, and the second driving signal N shown in FIG. 2C may be supplied to the X scan electrode.

As shown in FIG. 2B, if one X scan electrode is selected and the pulsed first driving signal P is supplied to the selected X scan electrode, the detection current may flow in the detection electrode coupled to the X scan electrode through capacitance. FIG. 2B shows the waveform of a current flowing in the detection electrode at the timing of rising and falling of the pulses when the first driving signal P is supplied to the X scan electrode. FIG. 2B shows a current waveform when during a period from the time ta to the time th, the finger is off from the x scan electrode, to which the first driving signal P is supplied, and since the time ti, the finger approaches the X scan electrode to which the first driving signal P is supplied. If the first driving signal P is supplied to the X scan electrode, a detection current ±Sp is liable to flow in the detection electrode that is coupled to the X scan electrode through capacitance. At the time ta, tc, te, and tg, since the first driving signal P rises, a current of a plus side from a reference value (0) may flow in the detection electrode. At the time tb, td, tf, and th, since the first driving signal P falls, a current of a minus side may flow in the detection electrode.

That is, a current of a waveform differentiated from the voltage waveform of the first driving signal P may flow in the detection electrode coupled to the X scan electrode, to which the first driving signal P is supplied, through capacitance. In FIG. 2B, the current value on the plus side is represented by +Sp, and the current value on the minus side is represented by −Sp.

Since the time ti of FIG. 2B, if the finger approaches the X scan electrode, to which the first driving signal P is supplied, the opposite area of the X scan electrode and the finger sufficiently becomes larger than the opposite area of the X scan electrode and the detection electrode. Capacitance that is formed between the finger at a substantially ground potential and the X scan electrode may become sufficiently larger than capacitance between the X scan electrode and the detection electrode. Accordingly, when the voltage of the first driving signal P changes in the X scan electrode, a current mainly flows in the finger. For this reason, since the time ti, the amount of current flowing in the detection electrode may become slight.

FIG. 2C shows a case where the finger does not approach a Y scan electrode, to which the second driving signal N is supplied. In this case, if the second driving signal N is supplied to the Y scan electrode, the detection current shown in FIG. 2D may flow in the detection electrode coupled to the Y scan electrode through capacitance.

The second driving signal N may have the opposite timing of rising and falling to the first driving signal P. For this reason, as shown in FIG. 2D, at the time ta, tc, te, and tg, the second driving signal N falls, and accordingly a current of the minus side from the reference value (0) may flow in the detection electrode. At the time tb, td, tf, and th, the second driving signal N rises, and accordingly a current of the plus side may flow in the detection electrode.

In FIG. 2D, the current value of the minus side is represented by −Sn, and the current value of the plus side is represented by +Sn. The current waveform corresponds to a waveform differentiated from the voltage waveform of the second driving signal N which is supplied to the Y scan electrode.

A detection electrode in which the detection current shown in FIG. 2B is liable to flow and a detection electrode in which the detection current shown in FIG. 2D is liable to flow may be collectively connected to the common detection line Sa, and the detection currents may be supplied to the detection unit 7. For this reason, during the period from the time ta to the time th, the detection current ±Sp and the detection current ±Sn that are to be generated in the detection electrode may cancel each other, such that the detection current which is supplied from the detection line Sa to the detection unit 7 may become substantially zero. Since the time ti, the detection signal ±Sp shown in FIG. 2B is attenuated, the detection current shown in FIG. 2D may be supplied from the detection line Sa, that is, the detection current ±Sn that flows on the basis of rising and falling of the second driving signal N is supplied to the detection unit 7.

The detection unit 7 may monitor the detection signal that is supplied from the detection line Sa with the time ta, tc, te, tg, ti, tk, . . . . Like the time ti, tk, . . . of FIG. 2D, a current value −sn is detected from the detection line Sa on the basis of the second driving signal N, it can be determined that the finger approaches the X scan electrode to which the first driving signal P is supplied. To the contrary, if a current value +Sp is detected from the detection line Sa on the basis of the first driving signal P, it can be determined that the finger approaches the Y scan electrode to which the second driving signal N is supplied.

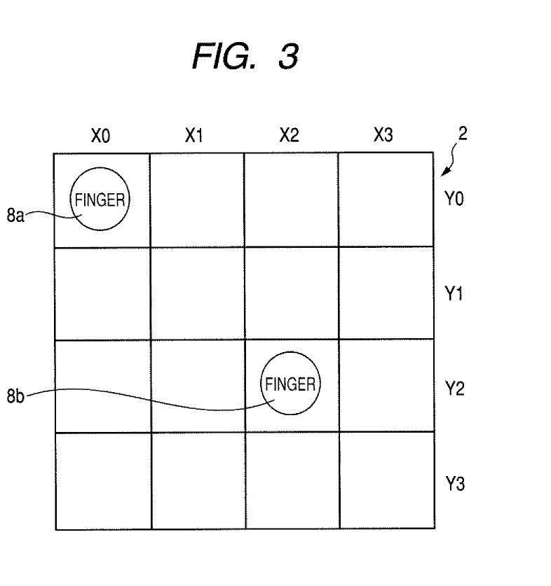

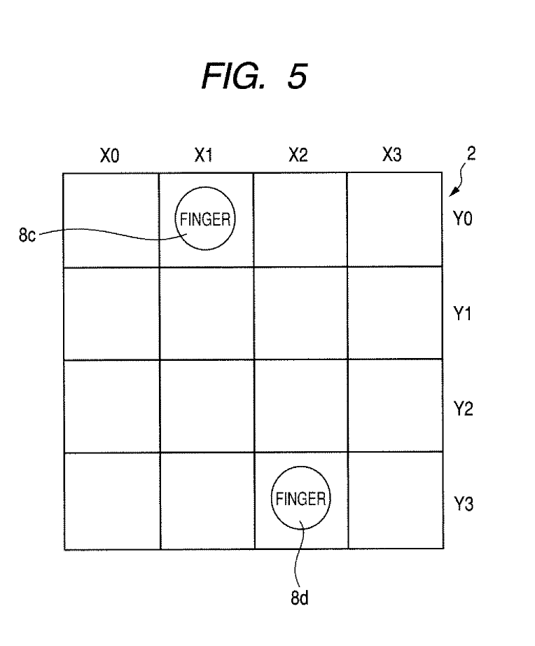

In FIG. 3, for convenience, the detection region 2 may be divided into 16 compartments. Each of the 16 compartments may have its center at the intersection of the X scan electrode and the Y scan electrode. The same may be applied to FIGS. 5, 7, and 9.

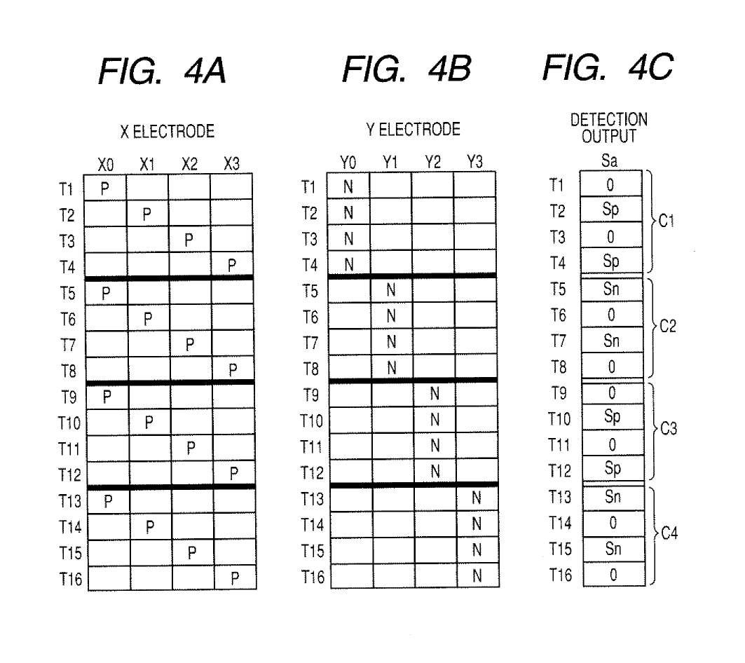

FIG. 4A shows the timing of application of the first driving signal P to the X scan electrodes X0, X1, X2, and X3. FIG. 4B shows the timing of application of the second driving signal N to the Y scan electrodes Y0, Y1, Y2, and Y3. FIG. 4C shows a detection current that is supplied from the detection line Sa to the detection unit 7. In FIGS. 4A to 4C, the scan time is represented by T1, T2, T3, . . . .

As shown in FIGS. 2A and 2C, the first driving signal P and the second driving signal N may be synchronized such that they are opposite in the rising and falling of the pulses. At each scan time, when the first driving signal P to be supplied to the X scan electrode rises, and simultaneously, the second driving signal N to be supplied to the Y scan electrode falls. Actually, at one scan time (for example, T1), the first driving signal P and the second driving signal N may be supplied in the form of a plural number of pulses.

As shown in FIGS. 4A and 42, with respect to the driving method of the input device 1, at the scan time T1, T2, T3, and T4 of a first cycle C1, the first driving signal P may be supplied sequentially from the X driver 5 to the X scan electrodes X0, X1, X2, and X3. In this case, the first driving signal P may be supplied sequentially to adjacent X scan electrodes. In addition, at the scan time T1, T2, T3, and T4, the second driving signal N may be supplied from the Y driver 6 to the same Y scan electrode Y0.

At the scan time T5, T6, T7, and T8 of a second cycle C2, the first driving signal P may be supplied sequentially from the X driver 5 to the X scan electrodes X0, x1, X2, and X3, and the second driving signal N may be supplied from the Y driver 6 to the same Y scan electrode Y1 in synchronization with the first driving signal P. At the scan time T9, T10, T11, and T12 of a third cycle C3, the first driving signal P may be supplied sequentially to the X scan electrodes X0, X1, X2, and X3, and the second driving signal N may be supplied to the same Y scan electrode Y2. At the scan time T13, T14, T15, and T16 of a fourth cycle C4, the first driving signal P may be supplied sequentially to the X scan electrodes X0, X1, X2, and X3, and the second driving signal N may be supplied to the same Y scan electrode Y3. The scan time T1 is next to the scan time T16, and thereafter, the driving signal may be switched in the same manner.

With this driving method, adjacent X scan electrodes X0, X1, X2, and X3 sequentially may be selected in each of the cycles C1, C2, C3, and C4, and in the same cycle, the same Y scan electrode may be selected. In each of the cycles C1, C2, C3, and C4, an adjacent Y scan electrode sequentially may be selected.

In the example of FIG. 3, during the period from the scan time T1 to the scan time T16, a first finger Sa may touch the surface of the detection region 2 at the intersection of the X scan electrode X0 and the Y scan electrode Y0, and a second finger 8b may touch the surface of the detection region 2 at the intersection of the X scan electrode X2 and the Y scan electrode Y2. FIG. 4C shows the detection output at that time.

At the scan time T1, the first driving signal P may be supplied to the X scan electrode X0, and the second driving signal N may be supplied to the Y scan electrode Y0. In this case, since the finger 8a approaches the X scan electrode X0 and the Y scan electrode Y0, when the pulsed first driving signal P is supplied, the current that flows in the detection electrode coupled to the X scan electrode X0 through capacitance may be attenuated. Similarly, when the pulsed second driving signal N is supplied, the current that flows in the detection electrode coupled to the Y scan electrode Y0 through capacitance may be attenuated. Therefore, as shown in FIG. 4C, the scan signal to be obtained at the scan time T1 may be substantially zero.

At the scan time T2, since the finger is not present on the x scan electrode X1 to which the first driving signal P is supplied, the detection current Sp shown in FIG. 2B may flow in the detection electrode. Meanwhile, since a finger 8a is present on the Y scan electrode Y0 to which the second driving signal N is supplied, the current flowing in the detection electrode may be attenuated due to a change in voltage of the Y scan electrode Y0. Therefore, as shown in FIG. 4C, at the scan time T2, the detection current Sp may be detected.

As shown in FIG. 2B, the detection current Sp that flows in the detection electrode by one pulse of the first driving signal S may be weak. For this reason, actually, at the scan time T1 of a predetermined length, a plurality of pulses may be supplied to the X scan electrode, and the detection current Sp flowing in the detection electrode may be accumulated by the number of pulses and detected by the detection unit 7. This is the same as a case where the detection current Sn flows in the detection electrode when the second driving signal N is supplied to the Y scan electrode. The detection unit 7 may calculate the cumulative value of the detection current Sn shown in FIG. 2D.

At the scan time T3, since the finger 8b is present on the X scan electrode X2 to which the first driving signal P is supplied, the current flowing in the detection electrode may be attenuated due to a change in voltage of the X scan electrode X2. Similarly, since the finger 8a is present on the Y scan electrode Y0 to which the second driving signal N is supplied, the current flowing in the detection electrode also may be attenuated due to a change in voltage of the Y scan electrode Y0. Therefore, as shown in FIG. 4C, at the scan time T3, the detection current to be obtained by the detection unit 7 may be substantially zero.

At the scan time T4, since a finger is not present on the X scan electrode X3 to which the first driving signal P is supplied, the detection current Sp may flow in the detection electrode due to the pulsed first driving signal P. Meanwhile, since the finger 8a is present on the Y scan electrode Y0 to which the second driving signal N may be supplied, the detection current that is liable to flow in the detection electrode due to the second driving signal N is attenuated. Therefore, as shown in FIG. 4C, at the scan time T4, the detection unit 7 detects the detection current Sp on the basis of the first driving signal P.

At the scan time T5, while the finger 8a is present on the X scan electrode X0 to which the first driving signal P is supplied, a finger may not be present on the Y scan electrode Y1 to which the second driving signal N is supplied. For this reason, the detection current Sn may flow in the detection unit 7 due to the second driving signal N. Similarly, at the scan time T7, while the finger 8b is present on the X scan electrode X2 to which the first driving signal P is supplied, and a finger is not present on the Y scan electrode Y1 to which the second driving signal N is supplied. For this reason, the detection current Sn may flow in the detection unit 7 due to the second driving signal N.

At the scan time T6, a finger may not be present on the X scan electrode X1 to which the first driving signal P is supplied, and a finger may not be present on the Y scan electrode Y1 to which the second driving signal N is supplied. Therefore, the current ±Sp shown in FIG. 2A may flow in the detection electrode due to the first driving signal P, and the current ±Sn shown in FIG. 2D may flow in the detection electrode due to the second driving signal N. Since the current ±Sp and the current ±Sn are opposite in polarity, they may be cancelled within the detection electrode, and as shown in FIG. 4C, at the scan time T6, the detection current to be detected by the detection unit 7 may be substantially zero. Similarly, at the scan time T8, a finger may not be present on the X scan electrode X3 to which the first driving signal P is supplied, and a finger is may not be present on the Y scan electrode Y1 to which the second driving signal N is supplied. Therefore, as shown in FIG. 4C, at the scan time T8, the detection current to be detected by the detection unit 7 may be substantially zero.

In such a manner, if the electrode selection operation from the scan time T1 to the scan time T16 is repeated, the two positions touched by the fingers 8a and 8b can be detected.

In the example of FIG. 4C, at the first scan time T5 and the third scan time T7 of the second cycle C2, the detection current Sn may be obtained on the basis of the second driving signal N which may be supplied to the Y scan electrode, rather than the detection current is obtained on the basis of the first driving signal P which may be supplied to the X scan electrode. Similarly, in the fourth cycle C4, the detection current Sn may be obtained at the first scan time T13 and the third scan time T16. Therefore, it can be recognized that the finger is present on the first X scan electrode X0 and the third X scan electrode X2.

In the first cycle C1 and the third cycle C3, the detection current Sn may be detected on the basis of the first driving signal P which may be supplied to the X scan electrode, rather than that the detection current is obtained on the basis of the second driving signal N which may be supplied to the Y scan electrode. Therefore, it can be recognized that the finger is present on the first Y scan electrode Y0 and the third scan electrode Y2.

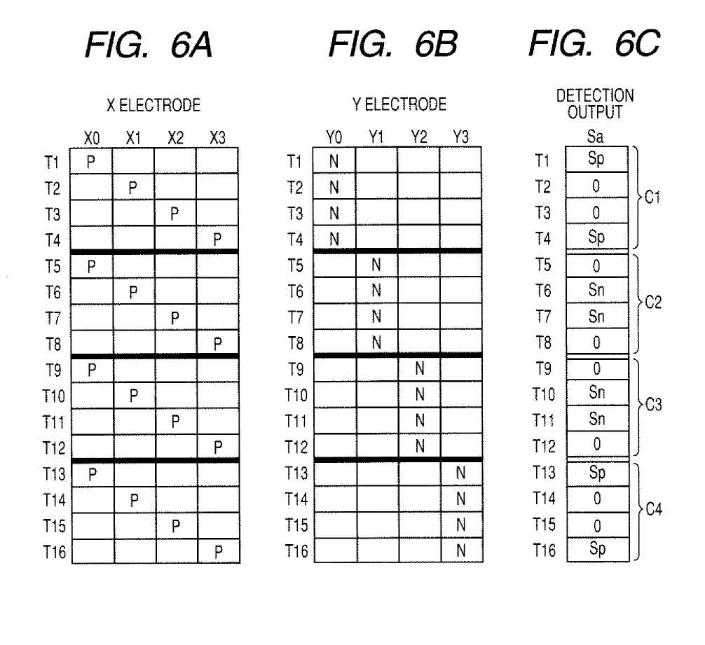

In FIG. 5, a finger 8c may be present on the intersection of the X scan electrode X1 and the Y scan electrode Y0, and a finger 8d may be present on the intersection of the X scan electrode X2 and the Y scan electrode Y3. As shown in FIGS. 6A and 6B, the selection operation of the X scan electrodes and the Y scan electrodes may be the same as the embodiment of FIGS. 4A and 4B.

In this case, as shown in FIG. 6C, at the second scan time T6 and the third scan time T7 of the second cycle C2 and the second scan time T10 and the third scan time T11 of the third cycle C3, the detection current Sn may be obtained on the basis of the second driving signal N which may be supplied to the Y scan electrode. Therefore, it can be recognized that the finger is present on the second X scan electrode X1 and the third X scan electrode X2. In addition, the detection current Sp due to the first driving signal P appears only in the first cycle C1 and the fourth cycle C4. For this reason, it can be recognized that the finger is present on the first Y scan electrode Y0 and the fourth Y scan electrode Y3.

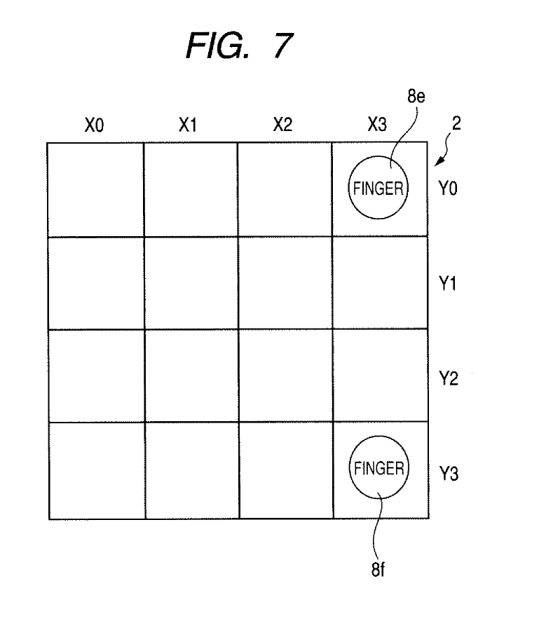

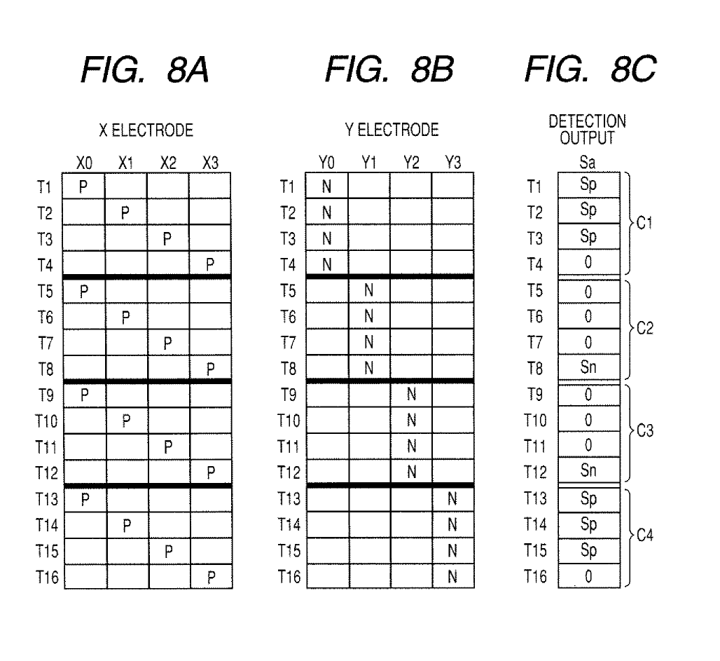

FIG. 7 shows a case where a finger 8e is present on the intersection of the X scan electrode X3 and the Y scan electrode Y0, and a finger 8f is present on the intersection of the same X scan electrode X3 and the Y scan electrode Y3. The driving method shown in FIGS. 8A and 8B may be the same as that in FIGS. 4A and 4B, and the detection output at that time is shown in FIG. 8C.

In this case, at the fourth scan time T8 of the second cycle C2 and the fourth scan time T12 of the third cycle C3, the detection current Sn may be obtained due to the second driving signal N which may be supplied to the Y scan electrode. Therefore, it can be recognized that the finger is present on the fourth X scan electrode X3. In addition, in the first cycle C1 and the fourth cycle C4, the detection current Sp may be detected due to the first driving signal P which may be supplied to the X scan electrode. Therefore, it can be recognized that the finger is present on the first Y scan electrode Y0 and the fourth Y scan electrode Y3.

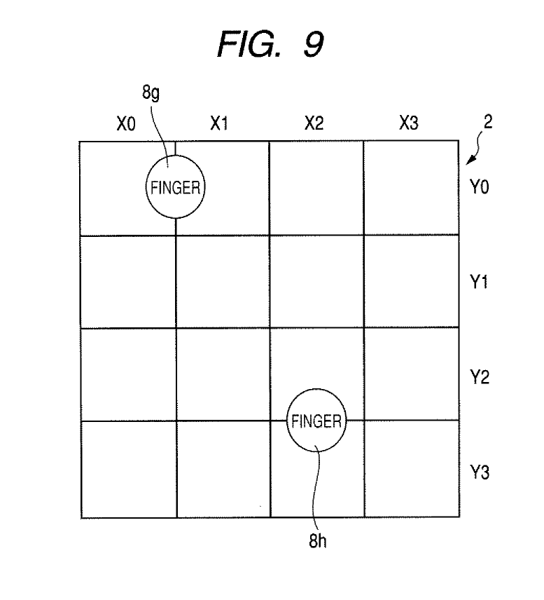

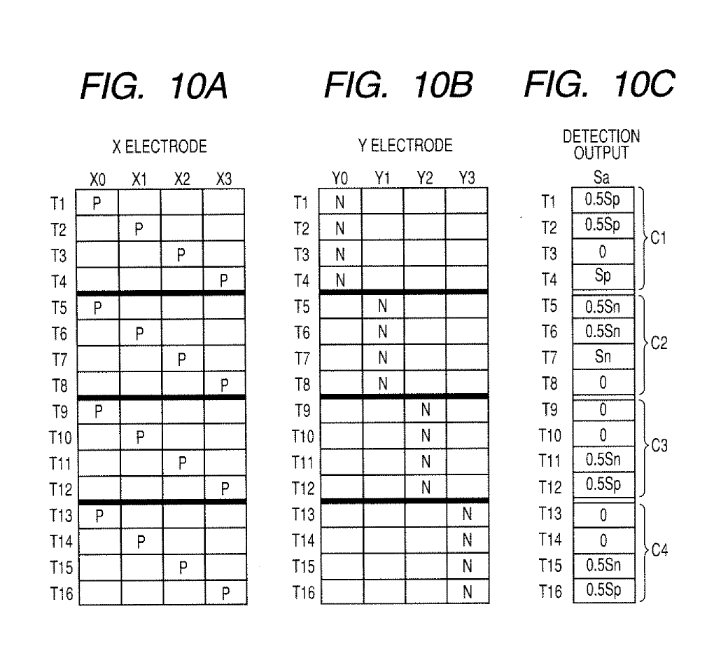

In FIG. 9, a finger 8g may be present on the Y scan electrode Y0 and at an intermediate point of the X scan electrode X0 and the X scan electrode X1, and a finger 8h may be present on the X scan electrode X2 and at an intermediate point of the Y scan electrode Y2 and the Y scan electrode Y3. The electrode selection operation shown in FIGS. 10A and 10B may be the same as in FIGS. 4A and 4B, and the detection output at that time is shown in FIG. 10C.

At the scan time T1, T2, T3, and T4, the finger 8g may be present on the Y scan electrode Y0 to which the second driving signal N is supplied. For this reason, the detection current Sn that may flow in the detection electrode on the basis of the second driving signal N may be attenuated and not detected. In addition, the finger 8g may be present at the intermediate point of the X scan electrode X0 and the X scan electrode X1. Therefore, at both the scan time T1 and the scan time T2, a current 0.5 Sp that is generated in the detection electrode due to the first driving signal P may be detected.

At the scan time T3, the finger 8h may be present on the X scan electrode X2 to which the first driving signal P may be supplied. For this reason, the detection current Sp that may flow in the detection electrode due to the first driving signal P is attenuated. Therefore, the detection current to be detected by the detection unit 7 may be substantially zero. At the scan time T4, since the finger may be present on the X scan electrode X3 to which the first driving signal P is supplied, the detection current to be obtained by the detection unit 7 may be Sp.

In the same manner, the detection output at each scan time since the scan time T5 may be obtained. For example, at the scan time T13, the influence of the finger 8g on the X scan electrode X0 to which the first driving signal P may be supplied is half, and the influence of the finger 8h on the Y scan electrode Y3 to which the second driving signal N may be supplied is half. Therefore, the detection current 0.5 Sp that may flow in the detection electrode due to the first driving signal P and the detection current 0.5 Sn that may flow in the detection electrode due to the second driving signal N may cancel each other, and the detection current may become substantially zero. In the same manner, at the scan time T6, the detection current may become substantially zero.

At the scan time T15, since the finger 8h is present on the X scan electrode X2 to which the first driving signal P is supplied, the detection current that may flow in the detection electrode due to the first driving signal P may be substantially zero. Meanwhile, half of the influence of the finger 8h may be applied to the Y scan electrode Y3 to which the second driving signal N is supplied. Therefore, the detection current to be obtained by the detection unit 7 at that time may be 0.5 Sn. At the scan time T16, since a finger may not be present on the X scan electrode X3 to which the first driving signal P is supplied, the detection current Sp may flow in the detection electrode due to the first driving signal P. In this case, since half of the influence of the finger 8h is applied to the Y scan electrode Y3 to which the second driving signal N is supplied, the detection current 0.5 Sn may flow in the detection electrode due to the second driving signal N. Since the detection current Sp and the detection current 0.5 Sn are opposite in polarity, at T16, the detection current 0.5 Sp may be obtained.

In the detection output of FIG. 1C, the detection signal 0.5 Sn due to the second driving signal N may appear at both the first scan time T5 and the second scan time T6 of the second cycle C2. Therefore, it can be recognized that the finger is present in the middle of the first X scan electrode X0 and the second X scan electrode X1. In addition, at the third scan time T11 of the third cycle C3 and the third scan time T15 of the fourth cycle C4, the detection current 0.5 Sn due to the second driving signal N may appear. As a result, it can be recognized that the finger is also present on the third X scan electrode X2.

In the first cycle C1, since only the detection currents 0.5 Sp and Sp due to the first driving signal P are detected, it can be detected that the finger is present on the first Y scan electrode Y0. In addition, the detection current may be detected on the basis of the first driving signal P in the third cycle C3 and the fourth cycle C4 with a shift of 0.5 Sp. Therefore, it can be detected that the finger is present in the middle of the third Y scan electrode Y2 and the fourth Y scan electrode Y3. Furthermore, the position of the finger having touched in the middle of adjacent electrode can also be recognized on the basis of the ratio of the detection currents Sp and Sn to be obtained at the respective scan time with high resolution.

This is because, in the same cycle, the first driving signal P is supplied sequentially to adjacent X scan electrodes X0, X1, X2, and X3, and in the continuous cycles C1, C2, C3, and C4, the second driving signal N is supplied sequentially to adjacent Y scan electrodes Y0, Y1, Y2, and Y3.

For example, how much the finger 8g is closer to which of adjacent X scan electrodes X0 and X1 can be detected on the basis of the magnitude ratio of the detection current Sp detected at the scan time T1 and the detection current Sp detected at the scan time T2 in FIG. 10C with high resolution. In addition, how much the finger 8h is closer to which of adjacent Y scan electrodes Y2 and Y3 can be detected on the basis of the magnitude ratio of the detection current Sn detected in the third cycle C3 and the detection current Sn detected in the fourth cycle C4 with high resolution.

According to various embodiments, two X scan electrodes and two Y scan electrodes may be sequentially selected and the driving signals may be supplied to the selected scan electrodes. For example, at the scan time T1, the first driving signal P may be supplied to both the X scan electrode X0 and the X scan electrode X1, and at the scan time T2, the first driving signal P may be supplied to both the X scan electrode X1 and the X scan electrode X2. Similarly, at the scan time T3, the first driving signal P may be supplied to both the X scan electrode X2 and the X scan electrode X3, and at the scan time T4, the first driving signal P may be supplied to both the X scan electrode X3 and the X scan electrode X0. Since the scan time T5, this operation may be repeated.

In addition, in the first cycle C1, the second driving signal N may be supplied to both the Y scan electrode Y0 and the Y scan electrode Y1, and in the second cycle C2, the second driving signal N may be supplied to both the Y scan electrode Y1 and the Y scan electrode Y2. In the third cycle C3, the second driving signal N may be supplied to both the Y scan electrode Y2 and the Y scan electrode Y3, and in the fourth cycle C4, the second driving signal N may be supplied to both the Y scan electrode Y3 and the Y scan electrode Y0.

It should be understood by those skilled in the art that various modifications, combinations, sub-combinations, alterations may occur depending on design requirements and other factors insofar as they are within the scope of the appended claims and the equivalents thereof.

Accordingly, the embodiments of the present inventions are not to be limited in scope by the specific embodiments described herein. Further, although some of the embodiments of the present invention have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

What is claimed is:

1. An input device comprising:
a plurality of X scan electrodes extending in a Y direction to be arranged with intervals in an X direction perpendicular to the Y direction;
a plurality of Y scan electrodes extending in the X direction to be arranged with intervals in the Y direction and insulated from the X scan electrodes;
detection electrodes forming electrostatic capacitance with the X scan electrodes and the Y scan electrodes;
an X driver supplying a pulsed driving signal to the X scan electrodes;
a Y driver supplying a pulsed driving signal to the Y scan electrodes; and
a detection unit detecting scan electrodes to be approached by a control object from detection signals to be obtained from the detection electrodes and the timing at which the driving signals are supplied to the X scan electrodes and the Y scan electrodes,
wherein the driving signal that is supplied from the X driver to the X scan electrodes and the driving signal that is supplied from the Y driver to the Y scan electrodes are opposite in the timing of rising and falling of the pulses, and at the same scan time, one X scan electrode and one Y scan electrode are selected simultaneously and the driving signals are supplied to the selected X and Y scan electrodes, and
wherein a predetermined number of repetitions of scan time be one cycle, and, in a first cycle, the same Y scan electrode is selected in all of the scan time and different X scan electrodes are selected at the respective scan time, and in a second cycle, a Y scan electrode different from the Y scan electrode in the first cycle is selected in all of the scan time and different X scan electrodes are selected at the respective scan time, and
the cycles where different Y scan electrodes are selected are repeated a predetermined number of times.

2. The input device according to claim 1,
wherein the detection unit is individually recognizable scan electrodes to be approached by a plurality of control objects from the detection signals to be obtained from the detection electrodes and the timing at which the driving signals are supplied to the X scan electrodes and the Y scan electrodes.

3. The input device according to claim 1,
wherein, in the same cycle, adjacent X scan electrodes are sequentially selected at the respective scan time.

4. The input device according to claim 2,
wherein, in the same cycle, adjacent X scan electrodes are sequentially selected at the respective scan time.

5. The input device according to claim 1,
wherein, in different cycles, adjacent Y scan electrodes are sequentially selected.

6. The input device according to claim 2,
wherein, in different cycles, adjacent Y scan electrodes are sequentially selected.
